(19) United States
(12) Patent Application Publication
(10) Pub. No.: US 2025/0297671 A1
(43) Pub. Date: Sep. 25, 2025

(54) BELT AS CONTINUOUS TENSION MEANS FOR CONVEYOR BELTS

(71) Applicant: ARNOLD JÄGER HOLDING GMBH, Hannover (DE)

(72) Inventor: Sebastian JÄGER, Hannover (DE)

(21) Appl. No.: 19/083,864

(22) Filed: Mar. 19, 2025

(30) Foreign Application Priority Data
Mar. 25, 2024 (EP) 24165928.3

(51) Int. Cl. F16H 7/08; A01D 87/02; F16G 1/22

(52) U.S. Cl. CPC F16H 7/08; F16G 1/22; A01D 87/02

(57) ABSTRACT

The present disclosure relates to a belt as a continuous tension means for conveyor belts including a fabric layer and a first and a second belt end interconnected via a belt connector, the belt connector comprising a first exterior end and second exterior end connected or connectable there to lying opposite one another in a longitudinal direction at the belt connector, where the first exterior end of the belt connector is connected to the first belt end and the second exterior end of the belt connector to the second belt end.

The present disclosure provides that between the respective exterior end of the belt connector and the respective belt end of the belt in each case a seam connection is formed, where in each case a thread penetrates both the respective exterior end and the respective belt end in multiple stitches.

### PRIORITY CLAIM

This application claims priority to European Patent Application No. EP24165928.3, filed Mar. 25, 2024, which is expressly incorporated by reference herein.

### BACKGROUND

The present disclosure relates to a belt, and particularly to a conveyor belt. More particularly, the present disclosure relates to conveyor belts of agricultural machines.

### SUMMARY

According to the present disclosure, a belt as a continuous (endless) tension means for conveyor belts, in particular, conveyor belts of agricultural machines, is provided, the belt comprising a first belt end and a second belt end interconnected via a belt connector as an additional component, where a seam connection is formed each between the respective outer end of the belt connector and the respective belt end of the belt, wherein one thread each penetrates both the outer end and the respective belt end in multiple stiches. Thus, an intermediate section is sewn between the belt ends to join them in an endless manner, where the das intermediate section may be flexibly adapted to the respective application and requirements.

This alone creates the advantage that the belt connector can be durably joined onto the belt ends in a simple manner by forming a seam, and can also be simply replaced in case of a defect of the belt connector, for example, in that the seam is loosened again and a new belt connector is sewn between the belt ends. Alternatively, it may also be provided to sever the belt ends just before the seams with the belt connector still sewed on, to suitably prepare the severed belt ends (depending on the embodiment) and to provide and sew on a new belt connector (depending on the embodiment) which will then be slightly longer to compensate for the shortening of the belt. Thus, a flexible and simple repair is provided.

Hereby, preferably, the connection via the seam is carried out via a receptacle at the respective belt end, for example, in the form of a notch or a step, and a correspondingly complementary receptacle counterpart at the belt connector, both of which, lying on top of one another, are being penetrated by the thread to create the seam connection. When the thread, in doing that, also penetrates at least one fabric layer both at the belt end and at the belt connector, the connection may be additionally reinforced since the thread is held also by the fabric under tensional load.

Hereby, such a configuration of the belt connector may be used in flat belts or cam belts, where in the case of a cam belt cams will be arranged also at the belt connector at its underside and/or upper side, where a spacing of the cams of the belt is maintained across the belt connector.

Hereby, the belt connector may be manufactured as one piece or in multiple pieces, where the belt connector in the multi-piece configuration comprises a first connector element with the first exterior end and with a first interior end as well as a second connector element with the second exterior end and with a second interior end, where a mechanical lock connection is formed between the interior ends of the two connector elements so as to create a continuous belt.

Hereby, according to one embodiment, a steel plate each is arranged at the interior ends of the connector elements, each having one or more connecting holes permeating the respective steel plate, where the respective steel plate is embedded, at least in part, into the polymer layer of the belt connector, where the interior ends of the two connector elements are placed on top of one another such that the connecting holes of the steel plates arranged thereon are aligned flush, and where at least one fastening element, for example, a rivet or a screw, is inserted through the aligning connecting holes so as to create the lock connection. This presents a belt connection that is simple to form and to manufacture, where to that end the steel plates are preferably sewn on to the respective connector element, where to that end the respective steel plate is preferably perforated so as to facilitate the needle penetrating through the steel plate when forming the sewing connection.

According to a further embodiment, at each of the interior ends of the connector elements of the belt connector at least one bushing, for example, a cylindrical bushing or a drop-shaped bushing, extending in a lateral direction is arranged, where the respective bushing is embedded into the polymer layer of the belt connector, where the interior ends of the two connector elements engage with one another, for example, like interlaced fingers, such that the bushings at the two connector elements are aligned with one another, where a connecting rod is inserted precisely fitting into the aligned bushings in a lateral direction so as to create the lock connection. This way, additionally, an articulated lock connection can be formed, where the generation of noise is avoided due to the embedding of the bushings in the polymer layer.

Hereby, in order to secure the positioning of the bushings in the polymer layer under tensile load, the at least one fabric layer of the respective connector element entwines the embedded bushing, where to that end an end region of the fabric layer within the polymer layer is folded back over a middle region of the fabric layer, where the middle region and the end region of the fabric layer are sewn together. Thus, in this case also a seam connection may be provided to secure the bushing and to improve the tensile strength of the continuous belt.

Additionally, the bushings may have an uneven wall thickness, for example, in that a first wall thickness of the bushing in the region of a contact surface of transmission of tension against which the connecting rod is drawn under a tensile load is thicker than a second wall thickness of the bushing that the bushing exhibits on the opposite side, where this is of advantage, in particular, in the case of a cylindrical embodiment of the respective bushing.

According to a further embodiment, at each of the interior ends of the connector elements of the belt connector at least one round bar may be arranged extending in a lateral direction, where the respective round bar is embedded within bridges at the interior ends into the polymer layer of the belt connector and a recess extends in a lateral direction between the bridges within which the respective round bar lies exposed, where, in the region of the bridges, the interior ends of the two connector elements lie in contact with one another, in particular, with their end faces in contact with one another, and at least one fixing element encompasses the round bars lying exposed in the recesses at the two connector elements to hold these together in a longitudinal direction and create the lock connection. This, too, allows for a creation of an articulated connection.

In this embodiment, too, the positioning of the round bars in the polymer layer under tensile load may be secured in that the at least one fabric layer of the respective connector element entwines the embedded round bar, where to that end an end region of the fabric layer within the polymer layer is folded back over a middle region of the fabric layer, where the middle region and the end region of the fabric layer are sewn together.

Hereby, the fixing element may comprise, for example, two C shaped end regions each having an upper leg and a lower leg, the two C shaped end regions being open towards one another in a symmetrically identical way and each forming a cavity in-between the legs, where the two round bars lying exposed in the recesses can each be positioned in one of the cavities to hold the two round bars and therewith the two connector elements together.

Alternatively, this can also be achieved in that the fixing element is configured as a ribbon or rope and placed around the two round bars lying exposed in the recesses, the ribbon-or rope-type fixing element being closed at a connection point by frictional connection and/or positive locking, for example, in the manner of a cable tie, to bring it into a closed shape and to hold the round bars together in a longitudinal direction.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows a belt circulating on a drive roller and a deflection roller with a belt connector;

FIG. 1A shows an embodiment variant of the belt connector according to FIG. 1;

FIGS. 2A and 2B show a seam connection between the belt ends of the belt according to FIG. 1 and the belt connector in various views;

FIGS. 3 and 4 show various embodiments of a one-piece belt connector for a flat belt or a cam belt respectively;

FIGS. 5A and 5B show a two-piece belt connector in a first embodiment;

FIGS. 6A-6E show a two-piece belt connector in a second embodiment;

FIGS. 7A-7D show a two-piece belt connector in a third embodiment; and

FIGS. 8A-8D show a two-piece belt connector in a fourth embodiment.

### DETAILED DESCRIPTION

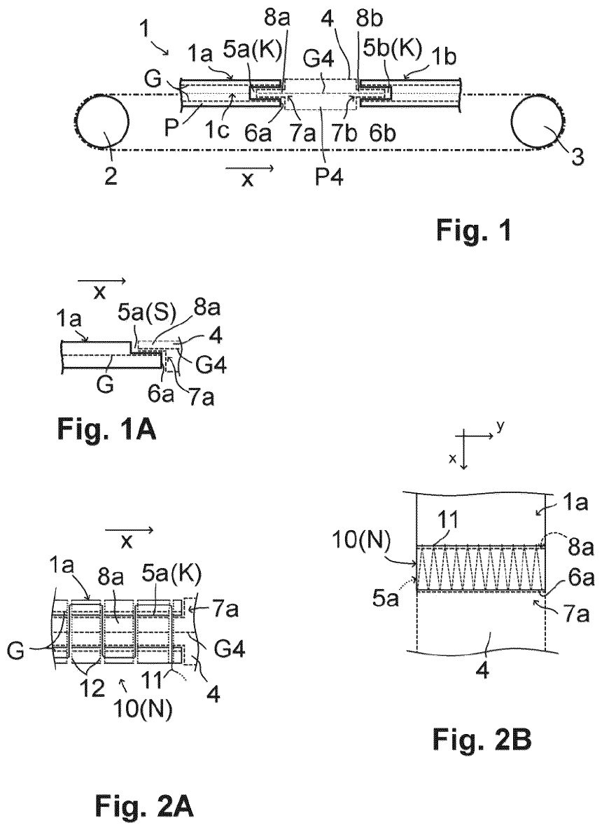

FIG. 1 schematically represents a continuous belt 1 as used, for example, for a transport belt or conveyor belt or agricultural machines. Hereby, the belt 1 revolves on a drive roller 2 and, depending on the application, on at least one deflection roller 3. Depending on the application, the belt 1 may be configured as a flat belt with a flat surface or as a flat belt with multiple cams. In all embodiments, the belt 1 comprises of at least one fabric layer G, preferably at least two fabric layers G, embedded in a polymer layer P, the fabric layer G serving as an all-around reinforcement of the belt 1.

In order to make such a belt 1 such that it can revolve on the drive roller 2 and the at least one deflection roller 3 in an endless manner, a belt connector 4 is provided, as indicated merely schematically in FIG. 1. Subsequently, various embodiments of such belt connector 4 will be further illustrated, where all embodiments have in common that the belt connector 4 is sewn on to the first and second (open) belt ends 1a, 1b of the belt 1 at both sides.

To that end, a (first or second respectively) receptacle 5a, 5b, e.g., in the form of a notch K (s. FIG. 1) or a step S (s. FIG. 1A) is provided each at the (first and second) belt ends 1a, 1b, the receptacle extending from an end face 6a, 6b of the respective belt end 1a, 1b in a longitudinal direction x or in the direction of movement of the belt 1, for example, across a length of between 15 mm and 150 mm. If the belt 1 has two fabric layers G, the respective receptacle 5a, 5b preferably runs between the two G approximately in a neutral fiber 1c of the belt 1, as shown in FIG. 1 for the notch K. If, however, only one fabric layer G is provided, the respective receptacle 5a, 5b correspondingly runs above or below the fabric layer G, i.e., above or below the neutral fiber 1c of the belt 1, as shown in FIG. 1A for the step S. Thus, there will be at least one fabric layer G above and/or below the receptacle 5a, 5b.

At the (first and second) exterior ends 7a, 7b of the belt connector 4 again a (first or second respectively) receptacle counterpart 8a, 8b is arranged which is arranged complementary to the respective receptacle 5a, 5b, for example, in the form of a bridge or also a step, as depicted. Preferably, there also extends at least one fabric layer G4 within the belt connector 4 up into the respective receptacle counterpart 8a, 8b. When the exterior ends 7a, 7b of the belt connector 4 are brought against the end faces 6a, 6b of the respective belt end 1a, 1b, the respective receptacle counterpart 8a, 8b can be positioned precisely fitting in one of the receptacles 5a, 5b.

When the receptacle counterpart 8a, 8b is positioned at the respective exterior end 7a, 7b in the receptacle 5a, 5b at the respective belt end 1a, 1b, a seam connection N is formed in a determined seam region 10, as shown in the FIGS. 2A, 2B in more detail. To that end, a thread 11 penetrates in accordance with a selected seam shape in multiple stitches 12 both the respective belt end 1a, 1b in the region of the receptacle 5a, 5b and the receptacle counterpart 8a, 8b positioned in the receptacle 5a, 5b at the respective exterior end 7a, 7b of the belt connector 4.

By means of this seam connection N the belt connector 4 can be affixed via the receptacle counterpart 8a, 8b at the respective belt end 1a, 1b. Because the respective fabric layers G, G4 run both at the respective belt end 1a, 1b up unit below and/or above the receptacle 5a, 5b and at the belt connector 4 bis in the receptacle counterpart 8a, 8b, the thread 11 penetrates also these fabric layers G, G4 that lie on top of one another in the multiple stitches 12, so that a high-strength and durable seam connection N is formed via which, in particular, in the continuous state of the belt 1 even high tension forces can be transmitted.

The advantage of such a seam connection N between the belt connector 4 and the belt ends 1a, 1b lies in that this can be severed again in case of a defect of the belt connector 4, for example, by loosening the thread 11. Thereafter, the seam connection N can be restored in a new sewing procedure with a replaced or repaired belt connector 4. Hereby, the stitches S do not destroy the respective belt end 1a, 1b to the extend as to render a new continuous connection no longer possible, a fact that is supported by the embedded fabric layers G, G4. Moreover, the new seam connection N may be formed suitably offset from the severed seam connection N so that a sufficiently high tensile strength via the belt connector 4 can be attained even after a new sewing procedure. Alternatively, it may be provided to sever the belt ends 1a, 1b, for example, just before the seams with the belt connector 4 still sewn on, to newly prepare the severed belt ends 1a, 1b in accordance with the respective embodiment, and to provide and sew on a new belt connector 4 according to the respective embodiment which will then be slightly longer to compensate for the shortened belt 1.

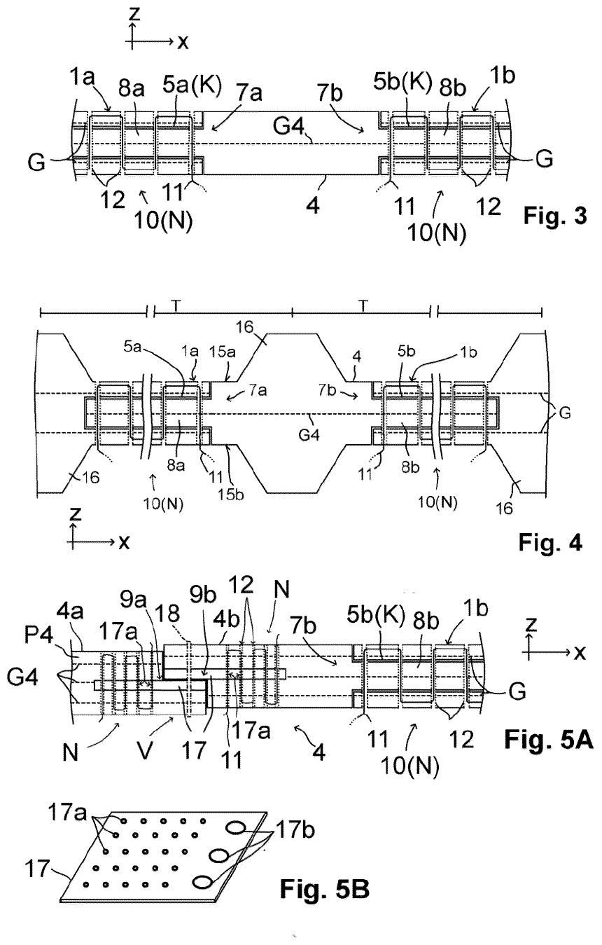

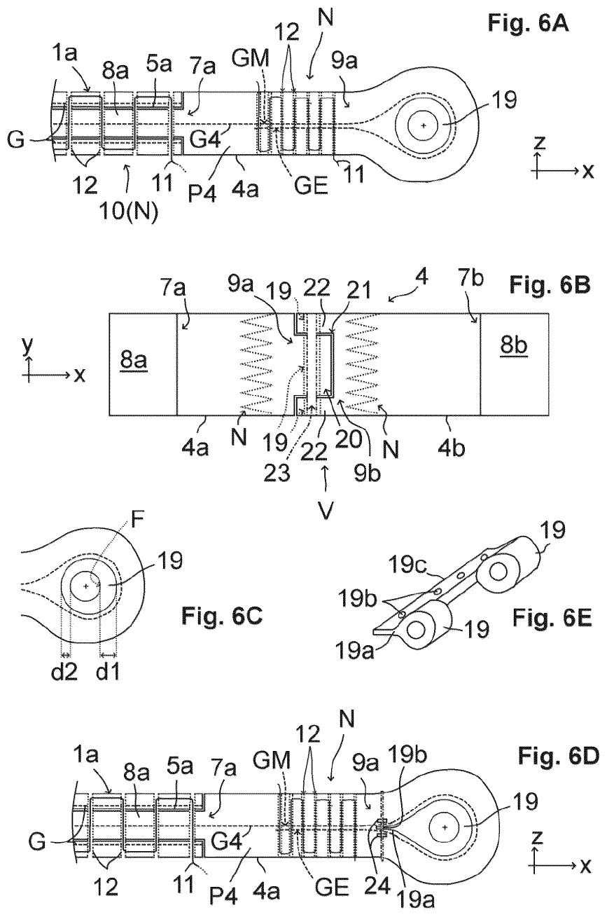

Hereby, the belt connector 4 itself may be configured as one piece (see FIG. 3 or 4) or comprises a first connector element 4a and a second connector element 4b (see FIGS. 5A, 5B, 6A-6E,7A-7D,8A-8D), where each connector element 4a, 4b is provided with one of the exterior ends 7a, 7b of the belt lock 4. Thus, each connector element 4a, 4b can be connected individually to the respective belt end 1a, 1b via the receptacle counterpart 8a, 8b at the respective exterior end 7a, 7b. Each connector element 4a, 4b further has interior ends 9a, 9b lying opposite the exterior ends 7a, 7b at the respective connector element 4a, 4b (in the longitudinal direction x). The interior ends 9a, 9b may be mechanically connected to one another via a selected lock connection V such that hereby, too, high tension forces can be transmitted in the continuous state of the belt 1. Below, various embodiments of the belt connector 4 shall be further illustrated:

According to the embodiment shown in FIG. 3, the belt connector 4 is made from a polymer layer P4 with at least one fabric layer G4 embedded therein for reinforcement. A thickness and a width of the belt connector 4 is adapted to a thickness and a width of the belt 1 so that the belt connector 4 does not project beyond the belt ends 1a, 1b in a lateral direction y and in a vertical direction z. The above-described receptacle counterparts 8a, 8b are arranged at the two exterior ends 7a, 7b of the belt connector 4 lying opposite in the longitudinal direction x, and can each be positioned precisely fitting in the receptacles 5a, 5b at the respective belt end 1a, 1b. Thereafter thee seam connection N can be formed so as to bring the belt 1 into a continuous shape via the belt connector 4 sewn in in-between.

According to the embodiment in FIG. 4, the belt connector 4 is configured as a molded part 15 comprising of a polymer layer P4 with at least one fabric layer G4 embedded therein. On an upper side 15a and an underside 15b of the molded part 15 a cam 16 each is formed, the cams 16 preferably being made one-piece with the polymer layer P4, so as to form a one-piece molded part 15. In this embodiment, the belt 1, too, comprises cams 16 on the upper side and underside configured as firm or loose cams and spaced apart from one another in the longitudinal direction x at a predetermined spacing T.

The above-described receptacle counterparts 8a, 8b are arranged at the exterior ends 7a, 7b of the belt connector 4 made as a molded part 15, and the counterparts can each be positioned precisely fitting in the receptacles 5a, 5b at the respective belt end 1a, 1b. Thereafter, the seam connection N can be formed so as to bring the belt 1 into a continuous form via the molded part 15 sewed in in-between. Hereby, the molded part 15 dimensioned and sewn together with the belt ends 1a, 1b such that the spacing T between the cams 16 is continued also across the belt connector 4.

In the embodiment according to FIG. 5A, the belt connector 4 is configured two-piece, where the first and the second connector element 4a, 4b are each made from a polymer layer P4 with three fabric layers G4 embedded therein for reinforcement. Further, a steel plate 17, in particular, spring steel sheet 17, each is embedded in each of the connector elements 4a, 4b a steel plate 17, at least in part into the polymer layer P4. The steel plate 17 has a perforation 17a as well as multiple connecting holes 17b, as shown in more detail in FIG. 5B.

Hereby, the interior ends 9a, 9b of the two connector elements 4a, 4b are stepped reciprocally such that the connecting holes 17b of the steel sheet 17 lie exposed while the perforation 17a of the steel sheet 17 remains embedded inside the fabric layer reinforced polymer layer P4. Hereby, the perforation 17a serves to form a seam connection N between the fabric layer reinforced polymer layer P4 and the steel plate 17. To that end, a thread 11 is pushed in multiple stitches 12 through the fabric layer reinforced polymer layer P4 as well as through the perforation 17a in the steel plate 17 so that the steel plate 17 is held on the continuous belt 1 securely at the respective interior end 9a, 9b of the respective connector element 4a, 4b under tensile loads.

The reciprocally stepped interior ends 9a, 9b of the two connector elements 4a, 4b are placed on top of one another such that the exposed regions of the steel plates 17 are in planar contact and the connecting holes 17b lies flush on top of one another. Suitable fastening elements 18, for example, screws or rivets, are introduced into the connecting holes 17b so as to form a screw or rivet connection as lock connection V.

The above-described receptacle counterparts 8a, 8b are arranged at the exterior ends 7a, 7b of the two connector elements 4a, 4b of this embodiment that lie opposite the interior ends 9a, 9b at the respective connector element 4a, 4b in the longitudinal direction x, and these counterparts can each be positioned in the receptacles 5a, 5b at the respective belt end 1a, 1b in a precise fitting manner (as shown in FIG. 5A for only one side). Thereafter a seam connection N can be made so as to bring the belt 1 in a continuous shape via the two connector elements 4a, 4b sewn in in-between and mechanically connected via the lock connection V.

In the embodiment according to FIG. 6A-6E, too, the belt connector 4 is configured two-piece, where the first and the second connector element 4a, 4b are each made from a polymer layer P4 including at least one fabric layer G4 embedded therein for reinforcement. Further, a bushing 19 is embedded, for example, vulcanized, into each of the connector elements 4a, 4b each at the interior end 9a, 9b. The bushing 19 has a cylindrical cross-section (s. FIG. 6A, 6C) or is drop-shaped (s. FIG. 6D, 6E). The fabric layer G4 and the polymer layer P4 of the respective connector element 4a, 4b entwines the embedded bushing 19, and an end region GE of the fabric layer G4 is folded back within the polymer layer P4 onto a middle region GM of the fabric layer G4. A thread 11 penetrates the respective connector element 4a, 4b in multiple stitches 12 such that the middle region GM and the end region GE of the fabric layer G4 are held together. This serves to hold the bushing 19 entwined by the fabric layer G4 securely on the interior end 9a, 9b even under tensile loads on the continuous belt 1.

As represented in FIG. 6B in a top view, the interior end 9a of the first connector element 4a exhibits a projection 20 into which the bushing 19 shown in FIG. 6A extends in a lateral direction y. The interior end 9b of the second connector element 4b exhibits a central recess 21 which is limited in the lateral direction y by two bridges 22 in each of which a bushing 19 extends. This way, the interior ends 9a, 9b of the two connector elements 4a, 4b can be inserted into one another such that all bushings 19 are aligned flush. A connecting rod 23 can be inserted through the aligned bushings 19 so as to form a mechanical lock connection V allowing for pivoting of the two connector elements 4a, 4b about the rod axis.

Hereby, the bushings 19 are made from hardened steel and the connecting rod 23 from a softer material. This causes the connecting rod 23 to wear out faster in operation than the embedded bushings 19. However, it is easier to replace the connecting rod 23 so that a quick repair can be provided. Furthermore, the hardened bushings 19 may have an uneven wall thickness, where a first wall thickness d1 in the region of a contact surface F of transmission of tensile load is thicker than a second wall thickness d2 on the opposite side of the bushing 19, as shown, by way of example, in FIG. 6C. This way, the bushings 19 are additionally reinforced in the direction of the highest load which makes them more durable.

According to FIG. 6D, in the case of the drop-shaped bushing 19 additional hold-down plates 24 are provided via which the bushing 19 can be additionally secured by means of a rivet or screw connection. Hereby, the tapered end 19a of the drop-shaped bushing 19 comprising additional apertures 19b is clamped in-between the screwed or riveted hold-down plates 24 which are embedded in the polymer layer P4, so as to provide additional fixation. However, the drop-shaped bushing 19 may also be used without such additional fixation at the tapered end 19a.

In addition, according to FIG. 6E, it may be provided that the two bushings 19 extending along the interior end 9b of the second connector element 4b in the two bridges 22 are interconnected via a laterally extending transition piece 19c. In this transition piece 19c, too, apertures 19b may be provided for fixation via the hold-down plates 24.

The above-described receptacle counterparts 8a, 8b are arranged at the exterior ends 7a, 7b of the two connector elements 4a, 4b of this embodiment that lie opposite the interior ends 9a, 9b at the respective connector element 4a, 4b in the longitudinal direction x, and these counterparts can each be positioned in the receptacles 5a, 5b at the respective belt end 1a, 1b in a precise fitting manner (see FIG. 6A, 6D). Thereafter a seam connection N can be made so as to bring the belt 1 in a continuous shape via the two connector elements 4a, 4b sewn in in-between and mechanically connected via the lock connection V.

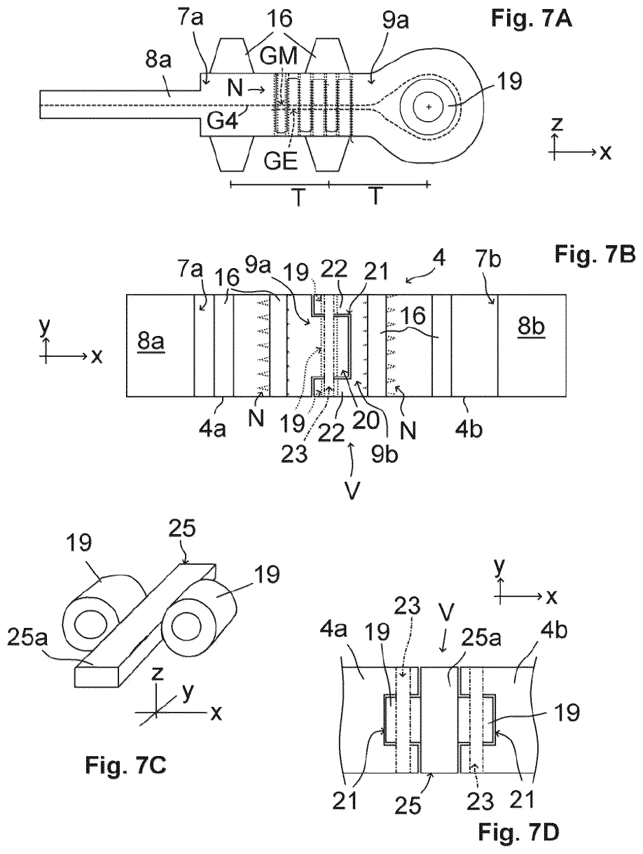

In the embodiment according to FIG. 7A-7D, too, the belt connector 4 is configured two-piece, where the first and the second connector element 4a, 4b are each made from a polymer layer P4 including at least one fabric layer G4 embedded therein for reinforcement. Further, a hardened bushing 19 is also embedded, for example, vulcanized, into each of the connector elements 4a, 4b each at the interior end 9a, 9b, into which a softer connecting rod 23 is inserted, as shown in FIG. 7B in a top view. The shape of the bushing 19 may be cylindrical or drop-shaped, for example, also with an uneven wall thickness, as in the previous embodiment according to FIG. 6A-6E. The difference to the above-described embodiment lies in the fact that the belt connector 4 is used in connection with a cam belt and, therefore, has individual cams 16. Hereby, the belt connector 4 with the embedded bushings 19 is configured such that even the bushings 19 or, respectively, the connecting rod 23 lie at the determined spacing T to the respective adjacent cam 16 so that the spacing T is continued across the belt connector 4. Hereby, the cams 16 can be vulcanized on to the respective connector element 4a, 4b after the seam connection N for holding together the fabric layers GM, GE has been made, or the cams 16 are configured as loose cams to be added later.

In FIG. 7C and 7D a further difference lies in the fact that an intermediate part 25 is fitted in-between the two connector elements 4a, 4b with embedded bushings 19, which part at the ends of which lying oppositive in the longitudinal direction x a bushing 19 each is provided, and these are interconnected via an intermediate bridge 25a. Das intermediate part 25 is preferably made as one piece from hardened steel. In this embodiment, the interior ends 9a, 9b of the respective connector elements 4a, 4b both exhibit a central recess 21 which is limited in the lateral direction y by two bridges 22 in each of which a bushing 19 extends in the lateral direction y. Die bushings 19 may be, for example, drop-shaped and configured with a transition piece, as illustrated in FIG. 6E, or may have another shape, as described in connection with the other embodiments.

This way, the intermediate part 25 with the two opposite bushings 19 can be inserted into the recesses 21 at the two interior ends 9a, 9b such that the bushings 19 at the intermediate part 25 and the respective connector elements 4a, 4b in the bridges 22 are aligned flush. Then a connecting rod 23 each may be inserted through the aligned bushings 19 so as to form a mechanical lock connection V. Since in this embodiment a picoting connection via two connecting rods 23 is made, a double joint is provided.

The above-described receptacle counterparts 8a, 8b are arranged at the exterior ends 7a, 7b of the two connector elements 4a, 4b of this embodiment that lie opposite the interior ends 9a, 9b at the respective connector element 4a, 4b in the longitudinal direction x, and these counterparts can each be positioned in the receptacles 5a, 5b at the respective belt end 1a, 1b in a precise fitting manner. Thereafter a seam connection N can be made so as to bring the belt 1 in a continuous shape via the two connector elements 4a, 4b sewn in in-between and mechanically connected via the lock connection V.

Hereby, the embodiment according to the FIGS. 7C and 7D with the intermediate part 25 can be used, given a suitable configuration of the interior ends 9a, 9b, also in a normal flat belt, as represented in the FIGS. 6A-6E.

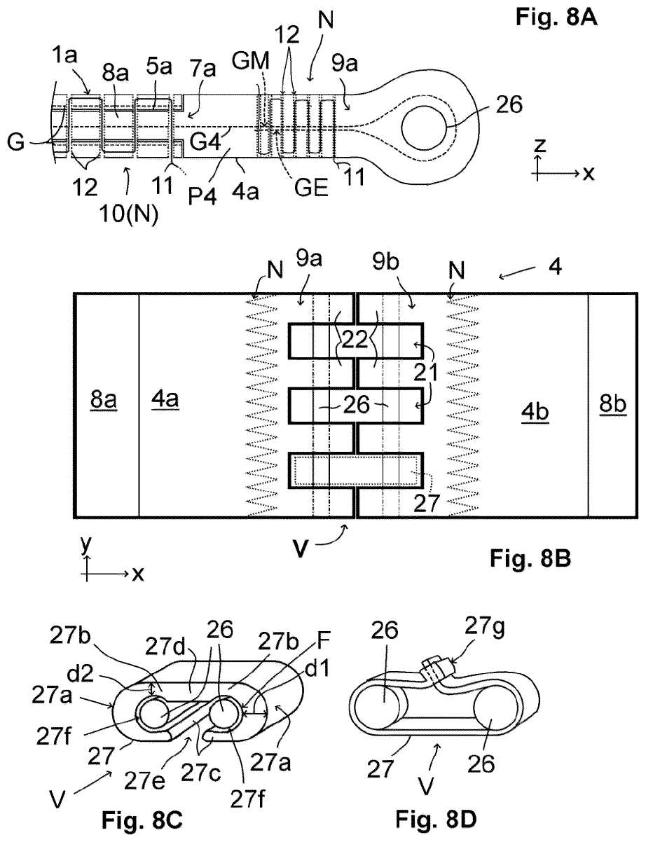

In the embodiment according to FIG. 8A-8D, too, the belt connector 4 is configured two-piece, where the first and the second connector element 4a, 4b are each made from a polymer layer P4 including at least one fabric layer G4 embedded therein for reinforcement. Further, a round bar 26, for example, a massive or, respectively, hardened round bar 26, is embedded, for example, vulcanized in, in each of the connector elements 4a, 4b each at the interior end 9a, 9b, as shown in FIG. 8A. Hereby, the placing of the embedded fabric layers G4 around the round bar 26 and the sewing of the folded-back fabric layer G4 happens in a way analog to the placing/sewing of the embedded fabric layer G4 around the bushing 19 according to the previous embodiments, so as to hold the round bar 26 securely on the respective connector element 4a, 4b under tension load on the continuous belt 1.

Further, a hardened bushing 19 is also embedded, for example, vulcanized, into each of the connector elements 4a, 4b each at the interior end 9a, 9b, into which a softer connecting rod 23 is inserted, as shown in FIG. 7B in a top view. The shape of the bushing 19 may be cylindrical or drop-shaped, for example, also with an uneven wall thickness, as in the previous embodiment according to FIG. 6A-6E. The difference to the above-described embodiment lies in the fact that the belt connector 4 is used in connection with a cam belt and, therefore, has individual cams 16. Hereby, the belt connector 4 with the embedded bushings 19 is configured such that even the bushings 19 or, respectively, the connecting rod 23 lie at the determined spacing T to the respective adjacent cam 16 so that the spacing T is continued across the belt connector 4. Hereby, the cams 16 can be vulcanized on to the respective connector element 4a, 4b after the seam connection N for holding together the fabric layers GM, GE has been made, or the cams 16 are configured as loose cams to be added later.

The two interior ends 9a, 9b of the respective connector elements 4a, 4b each exhibit one or more recess(es) 21, as shown in FIG. 8B, that is/are limited in the lateral direction y by bridges 22. Hereby, the round bar 26 extends in the lateral direction y through the individual bridges 22 into which it is embedded, thereby openly bridging the recess(es) 21. For a connection of the two interior ends 9a, 9b the recesses 21 of both connector elements 4a, 4b merge or, respectively, the bridges 22 of both connector elements 4a, 4b lie with their end faces in contact with one another. Thus, the two connector elements 4a, 4b lie opposite in opposing directions

In order to make a lock connection V between the two, a fixing element 27 is provided, two different embodiments of which are shown in the FIGS. 8C and 8D. In all embodiments, the fixing element 27 may encompass the round bars 26 that lie in parallel exposed within the recesses 21 of both connector elements 4a, 4b merging in the longitudinal direction x. Hereby, the two round bars 26 and also the two connector elements 4a, 4b are held together. Such a fixing element 27 may be provided for each of the merging recesses 21 separated by the bridges 22 so that the two round bars 26 are evenly held together across the entire width of the belt 1. Also, a single combined fixing element 27 may be provided that may simultaneously encompass all exposed round bars 26 in the multiple recesses 21.

In the embodiment according to FIG. 8C, the fixing element 27 exhibits two C shaped end regions 27a each having an upper leg 27b and a lower leg 27c, the two C shaped end regions 27a opening towards one another mirror-symmetrically. The uppers legs 27b of the two C shaped end regions 27a are interconnected via a middle bridge 27d, while the lower legs 27c remain separate so that a lower gap 27e is formed between the two. Through the lower gap 27e, the two round bars 26 lying exposed in the recesses 21 can each be positioned in a cavity 27f formed by the respective legs 27b, 27c of a C shaped end region 27a so that this fixing element 27 encompasses both round bars 26.

When the two connector elements 4a, 4b in the continuous state of the belt 1 are stretched, the C shaped end regions 27a arranged mirror-symmetrically provide that the round bars 26 cannot slip out of the cavity 27f via the gap 27e, thereby being permanently clamped or held together respectively. This way, a durable mechanical lock connection V is formed.

The C shaped end regions 27a may further exhibit an uneven wall thickness, where a first wall thickness d1 in the region of the contact surface F of transmission of tensile load is thicker than a second wall thickness d2 of the leg 27b, 27c having a reduced load, as show, by way of example, in FIG. 8C. This way, the fixing element 27 configured in this manner is additionally reinforced in the direction of the highest load making it more durable.

In the embodiment according to FIG. 8D, the fixing element 27 is configured as a band or rope and is placed around the two round bars 26 that lie in parallel exposed within the merging recesses 21 of both connector elements 4a, 4b and then closed. In this case, the band- or rope-type fixing element 27 is preferably made of steel and is brought into a closed shape at a connection point 27g by frictional connection and/or positive locking, for example, by crimping or screwing or snapping-in, for example, in the manner of a cable tie. This also holds the two round bars 26 together and creates a durable mechanical lock connection V.

The above-described receptacle counterparts 8a, 8b are arranged at the exterior ends 7a, 7b of the two connector elements 4a, 4b in this embodiment that lie opposite the interior ends 9a, 9b at the respective connector element 4a, 4b in the longitudinal direction x, and these counterparts can each be positioned perfectly fitting in the receptacles 5a, 5b at the respective belt end 1a, 1b. Thereafter a seam connection N can be made so as to bring the belt 1 into a continuous form via the two connector elements 4a, 4b sewn in-between and mechanically connected via the lock connection V.

The present disclosure relates to a belt as a continuous (endless) tension means for conveyor belts according to the preamble of claim 1, in particular, for conveyor belts of agricultural machines.

A comparative belt of this type has been used in a machine for picking up and pressing of harvested agricultural crop, e.g., hay or straw. Such a machine is provided with a bale conveyor having two spaced-apart belts interconnected by transverse rods spaced-apart in parallel. The belts are made of a plastics material or rubber and reinforced by at least one fabric layer.

In order to be usable, the belts may be in a continuous shape. There are various comparative manufacturing approaches for making belts of an endless shape:

In one comparative method, the belt ends of the belt are interlocked in a chamber-like fashion and to push the interlocking regions into one another to create the continuousness of the belt and then to vulcanize them. In another comparative method, metal fittings are affixed to both belt ends which are configured substantially u-shaped and arranged alternatingly at the belt ends. The legs of the fittings enclose the belt ends in-between them under pressure and are fastened by rivets penetrating through the belt ends. The roughly semi-circular rod of the fittings connecting the legs are alternatingly in contact with a rod extending across the entire width of the belt ends and is inserted after the assembly of the conveyor belt and is pulled out for disassembly of the conveyor. The rod is made of a suitable metal, however, it may alternatively be configured as a strong wire cable. Hereby, it is a disadvantage that the fittings will wear over time due to friction in the region of the semi-circular rods requiring replacement of the belt.

A further comparative belt connection involving a rod, where the rod or bolt is inserted in a transverse boring around which the ends of vulcanized reinforcement layers of the belt are flipped over. Each belt end exhibits such a transverse boring so that the rod can be guided through the transverse borings of the two belt ends hinged into one another thereby holding together the two belt ends.

In another comparative process of making endless a tension means configured as a cam belt happens by means of a belt joint as a belt connector. Such belt joints in various embodiments are often used for making endless tension means for conveyor belts of agricultural machines.

A further comparative flat belt made from a fabric layer reinforced polymer as a tension means may be used. The process of making endless this belt happens in that it contains multiple steps across the entire width at both ends. This creates an area of overlapping in which a first end region of the belt and a second end region of the belt lie overlappingly on top f one another. At the underside of the belt there are equally spaced grooves extending perpendicular to the longitudinal direction which serve for receiving anchor plates in the region of overlapping. Each anchor plate exhibits to welded and spaced-apart screw bolts. When the belt ends are placed on top of one another these screw bolts protrude into aligned flush holes provided in the belt ends. Nuts are screwed onto the ends of the screw bolts protruding from the belt and firmly tightened thereby pressing the belt ends firmly together so as to transmit tensile forces.

A disadvantage of these comparative belt connection is that they are expensive to make and may cause disturbing noise in operation due to metal parts hitting against other components in the region of the belt connection, e.g., toothed wheels or rollers or the like. Moreover, it is a problem to suitably affix the belt connection to the belt ends and/or to replace it in case of defect.

In another comparative example, the belt ends of the belt may be connected directly by means of one or more seams.

It is the object of the present disclosure to provide a belt which is simple and flexible to manufacture and to repair and, at the same time, is configured to be highly robust or durable therefore long operating times.

This task is solved by a belt according to claim 1. Hereby, preferred further developments are specified in the sub-claims.

Thus, according to the present disclosure, a belt as a continuous (endless) tension means for conveyor belts, in particular, conveyor belts of agricultural machines, is provided, the belt comprising a first belt end and a second belt end interconnected via a belt connector as an additional component, where a seam connection is formed each between the respective outer end of the belt connector and the respective belt end of the belt, wherein one thread each penetrates both the outer end and the respective belt end in multiple stiches. Thus, an intermediate section is sewn between the belt ends to join them in an endless manner, where the das intermediate section may be flexibly adapted to the respective application and requirements.

This alone creates the advantage that the belt connector can be durably joined onto the belt ends in a simple manner by forming a seam, and can also be simply replaced in case of a defect of the belt connector, for example, in that the seam is loosened again and a new belt connector is sewn between the belt ends. Alternatively, it may also be provided to sever the belt ends just before the seams with the belt connector still sewed on, to suitably prepare the severed belt ends (depending on the embodiment) and to provide and sew on a new belt connector (depending on the embodiment) which will then be slightly longer to compensate for the shortening of the belt. Thus, a flexible and simple repair is provided.

Hereby, preferably, the connection via the seam is carried out via a receptacle at the respective belt end, for example, in the form of a notch or a step, and a correspondingly complementary receptacle counterpart at the belt connector, both of which, lying on top of one another, are being penetrated by the thread to create the seam connection. When the thread, in doing that, also penetrates at least one fabric layer both at the belt end and at the belt connector, the connection may be additionally reinforced since the thread is held also by the fabric under tensional load.

Hereby, such a configuration of the belt connector may be used in flat belts or cam belts, where in the case of a cam belt cams will be arranged also at the belt connector at its underside and/or upper side, where a spacing of the cams of the belt is maintained across the belt connector.

Hereby, the belt connector may be manufactured as one piece or in multiple pieces, where the belt connector in the multi-piece configuration comprises a first connector element with the first exterior end and with a first interior end as well as a second connector element with the second exterior end and with a second interior end, where a mechanical lock connection is formed between the interior ends of the two connector elements so as to create a continuous belt.

Hereby, according to one embodiment, a steel plate each is arranged at the interior ends of the connector elements, each having one or more connecting holes permeating the respective steel plate, where the respective steel plate is embedded, at least in part, into the polymer layer of the belt connector, where the interior ends of the two connector elements are placed on top of one another such that the connecting holes of the steel plates arranged thereon are aligned flush, and where at least one fastening element, for example, a rivet or a screw, is inserted through the aligning connecting holes so as to create the lock connection. This presents a belt connection that is simple to form and to manufacture, where to that end the steel plates are preferably sewn on to the respective connector element, where to that end the respective steel plate is preferably perforated so as to facilitate the needle penetrating through the steel plate when forming the sewing connection.

According to a further embodiment, at each of the interior ends of the connector elements of the belt connector at least one bushing, for example, a cylindrical bushing or a drop-shaped bushing, extending in a lateral direction is arranged, where the respective bushing is embedded into the polymer layer of the belt connector, where the interior ends of the two connector elements engage with one another, for example, like interlaced fingers, such that the bushings at the two connector elements are aligned with one another, where a connecting rod is inserted precisely fitting into the aligned bushings in a lateral direction so as to create the lock connection. This way, additionally, an articulated lock connection can be formed, where the generation of noise is avoided due to the embedding of the bushings in the polymer layer.

Hereby, in order to secure the positioning of the bushings in the polymer layer under tensile load, the at least one fabric layer of the respective connector element entwines the embedded bushing, where to that end an end region of the fabric layer within the polymer layer is folded back over a middle region of the fabric layer, where the middle region and the end region of the fabric layer are sewn together. Thus, in this case also a seam connection may be provided to secure the bushing and to improve the tensile strength of the continuous belt.

Additionally, the bushings may have an uneven wall thickness, for example, in that a first wall thickness of the bushing in the region of a contact surface of transmission of tension against which the connecting rod is drawn under a tensile load is thicker than a second wall thickness of the bushing that the bushing exhibits on the opposite side, where this is of advantage, in particular, in the case of a cylindrical embodiment of the respective bushing.

According to a further embodiment, at each of the interior ends of the connector elements of the belt connector at least one round bar may be arranged extending in a lateral direction, where the respective round bar is embedded within bridges at the interior ends into the polymer layer of the belt connector and a recess extends in a lateral direction between the bridges within which the respective round bar lies exposed, where, in the region of the bridges, the interior ends of the two connector elements lie in contact with one another, in particular, with their end faces in contact with one another, and at least one fixing element encompasses the round bars lying exposed in the recesses at the two connector elements to hold these together in a longitudinal direction and create the lock connection. This, too, allows for a creation of an articulated connection.

In this embodiment, too, the positioning of the round bars in the polymer layer under tensile load may be secured in that the at least one fabric layer of the respective connector element entwines the embedded round bar, where to that end an end region of the fabric layer within the polymer layer is folded back over a middle region of the fabric layer, where the middle region and the end region of the fabric layer are sewn together.

Hereby, the fixing element may comprise, for example, two C shaped end regions each having an upper leg and a lower leg, the two C shaped end regions being open towards one another in a symmetrically identical way and each forming a cavity in-between the legs, where the two round bars lying exposed in the recesses can each be positioned in one of the cavities to hold the two round bars and therewith the two connector elements together.

Alternatively, this can also be achieved in that the fixing element is configured as a ribbon or rope and placed around the two round bars lying exposed in the recesses, the ribbon-or rope-type fixing element being closed at a connection point by frictional connection and/or positive locking, for example, in the manner of a cable tie, to bring it into a closed shape and to hold the round bars together in a longitudinal direction.

The present disclosure relates to a belt as a continuous tension means for conveyor belts including a fabric layer (G) and a first and a second belt end (1a, 1b) interconnected via a belt connector (4), the belt connector (4) comprising a first exterior end (7a) and second exterior end (7b) connected or connectable there to lying opposite one another in a longitudinal direction (x) at the belt connector (4), where the first exterior end (7a) of the belt connector (4) is connected to the first belt end (1a) and the second exterior end (7b) of the belt connector (4) to the second belt end (1b).

The present disclosure provides that between the respective exterior end (7a, 7b) of the belt connector (4) and the respective belt end (1a, 1b) of the belt (1) in each case a seam connection (N) is formed, where in each case a thread (11) penetrates both the respective exterior end (7a, 7b) and the respective belt end (1a, 1b) in multiple stitches (12).

### LIST OF REFERENCE NUMERALS

1 belt
1a first belt end
1b second belt end
1c neutral fiber of the belt 1
2 drive roller
3 deflection roller
4 belt connector
4a first connector element
4b second connector element
4c neutral fiber of the belt connectors
5a first receptacle
5b second receptacle
6a end face of the first belt end 1a
6b end face of the second belt end 1b
7a first exterior end of the belt connector 4
7b second exterior end of the belt connector 4
8a first receptacle counterpart
8b second receptacle counterpart
9a interior end of the first connector element 4a
9b interior end of the second connector element 4b
10 seam area
11 thread
12 stitch
15 molded part
15a upper side of the molded parts 15
15b underside of the molded parts 15
16 cams
17 steel plate
17a perforation
17b connecting holes
18 fastening element
19 bushing
19a tapered end of the bushing 19
19b apertures
19c transition piece
20 projection
21 recess
22 bridges of the recess 21
23 connecting rod
24 hold-down plate
25 intermediate part
25a intermediate bridge of the intermediate part 25
26 round bar
27 fixing element
27a end regions of the fixing element
27b upper leg
27c lower leg
27d middle bridge
27e lower gap
27f cavity
27g connection point
d1 first wall thickness
d2 second wall thickness
F contact surface of the transmission of tensile load
G fabric layer of the belt 1
G4 fabric layer of the belt connector 4
GE end region of the fabric layer G4
GM middle region of the fabric layer G4
K notch
N seam connection
P polymer layer of the belt 1
P 4 polymer layer of the belt connector 4
S step
T spacing
V lock connection
x longitudinal direction
y lateral direction
z vertical direction

1. A belt as a continuous (endless) tension means for conveyor belts, in particular, conveyor belts of agricultural machines, including at least one fabric layer embedded at least in part into a polymer layer, the belt comprising a first belt end and a second belt end interconnected via a belt connector to form a continuous belt, the belt connector having a first exterior end and a second exterior end connected or connectable there to lying opposite one another in a longitudinal direction at the belt connector, the first exterior end of the belt connector being connected to the first belt end, and the second exterior end of the belt connector to the second belt end,
wherein between the respective exterior end of the belt connector and the respective belt end of the belt a seam connection each is formed in which in each case a thread penetrates both the respective exterior end and the respective belt end in multiple stitches.

2. The belt of claim 1, wherein each belt end a receptacle is arranged, for example, in the form of a notch or a step, and at each exterior end of the belt connector a receptacle counterpart is arranged which is shaped complementary to the receptacle, where the receptacle counterpart at the respective exterior end can be positioned on or in the receptacle at the respective belt end with perfect fit such that the receptacle and the receptacle counterpart lie on top of one another in a vertical direction and the thread penetrates the respective belt end at least in the region of the receptacle as well as the respective exterior end at least in the region of the receptacle counterpart in a vertical direction.

3. The belt of claim 2, wherein the at least one fabric layer at the belt end extends at least up to the region of the receptacle so that the thread penetrates also the fabric layer at the respective belt end.

4. The belt of claim 1, wherein the belt connector is arranged as one piece or multiple pieces, and the belt connector comprises a polymer layer into which at least one fabric layer is embedded.

5. The belt of claim 4, wherein the belt connector in the multiple-piece configuration comprises
a first connector element with the first exterior end and with a first interior end as well as
a second connector element with the second exterior end and with a second interior end,
where a mechanical lock connection is formed between the interior ends of the two connector elements.

6. The belt of claim 5, wherein at each of the interior ends of the connector elements of the belt connector a steel plate is arranged having one or more connecting holes penetrating the respective steel plate in a vertical direction, the respective steel plate being embedded at least in part in the polymer layer of the belt connector,
the interior ends of the two connector elements being placed on top of one another such that the connecting holes of the steel plates arranged thereon lie aligned flush, and
where at least one fastening element is inserted through the aligned connecting holes so as to create the lock connection.

7. The belt of claim 6, wherein the respective steel plate is sewn on to the respective connector element, where, to that end, the respective steel plate is preferably provided with a perforation.

8. The belt of claim 5, wherein at each of the interior ends of the connector elements of the belt connector at least one bushing is arranged extending in a lateral direction, the respective bushing being embedded in the polymer layer of the belt connector,
the interior ends of the two connector elements engaging with one another, for example, like interlaced fingers, such that the bushings at the two connector elements are aligned with one another,
where a connecting rod is inserted precisely fitting into the aligned bushings in a lateral direction so as to create the lock connection.

9. The belt of claim 8, wherein the at least one fabric layer of the respective connector element entwines the embedded bushing, where, to that end, an end region of the fabric layer within the polymer layer is folded back over a middle region of the fabric layer, where the middle region and the end region of the fabric layer are sewn together.

10. The belt of claim 9, wherein the bushings have an uneven wall thickness, where a first wall thickness of the bushing in the region of a contact surface of transmission of tensile load against which the connecting rod is drawn under a tensile load is thicker than a second wall thickness of the bushing that the bushing exhibits on the opposite side.

11. The belt of claim 8, wherein the bushings are configured as drop-shaped, where a tapered end of the respective bushing is clamped in between two hold-down plates embedded in the polymer layer.

12. The belt of claim 5, wherein at each of the interior ends of the connector elements of the belt connector at least one round bar is arranged extending in a lateral direction, where the respective round bar is embedded within bridges at the interior ends into the polymer layer of the belt connector, and a recess extends in a lateral direction between the bridges within which the respective round bar lies exposed, where, in the region of the bridges, the interior ends of the two connector elements lie in contact with one another, in particular, with their end faces in contact with one another, and at least one fixing element encompasses the round bars lying exposed in the recesses at the two connector elements to hold these together in a longitudinal direction and create the lock connection.

13. The belt of claim 12, wherein the fixing element comprises two C shaped end regions each having an upper leg and a lower leg, the two C shaped end regions being open towards one another in a symmetrically identical way, the upper legs of the two C shaped end regions being connected to one another via a middle bridge, while the lower legs are separate from one another, so that a lower gap is formed in-between the two, where the two round bars lying exposed in the recesses are each positioned in a cavity formed by the legs of the respective C shaped end region.

14. The belt of claim 12, wherein the fixing element is configured as a ribbon or rope and placed around the two round bars lying exposed in the recesses, the ribbon-or rope-type fixing element being closed at a connection point by frictional connection and/or positive locking to bring it into a closed shape and to hold the round bars together in a longitudinal direction.

15. The belt of claim 1, wherein the cams are arranged at the belt connector and/or at the belt on the bottom side and/or upper side, where a spacing of the cams is maintained across the belt connector.
